(19) United States
(12) Patent Application Publication
(10) Pub. No.: US 2021/0326196 A1
(43) Pub. Date: Oct. 21, 2021

(54) A REMEDIATION SYSTEM TO PREVENT INCOMPATIBLE PROGRAM MODULE INSTALLATION IN AN INFORMATION PROCESSING SYSTEM

(71) Applicant: RIMO CAPITAL LTD., London, Greater London (GB)

(72) Inventor: Alon MOSS, London, Greater London (GB)

(73) Assignee: RIMO CAPITAL LTD., London, Greater London (GB)

(21) Appl. No.: 17/267,780

(22) PCT Filed: Aug. 9, 2019
(86) PCT No.: PCT/GB2019/052250

§ 371 Date: Feb. 10, 2021

(30) Foreign Application Priority Data
Aug. 10, 2018 (GB) 1813126.8
Jul. 9, 2019 (GB) 1909840.9

(51) Int. Cl. G06F 11/00; G06F 11/36; G06F 9/50; G06F 9/455

(52) U.S. Cl. CPC G06F 11/008; G06F 11/3692; G06F 11/368; G06F 9/45504; G06F 11/3696; G06F 9/5077; G06F 11/3676

(57) ABSTRACT

A test server system provides a test server (5) situated behind an enterprise network firewall (4). The test server is arranged to capture an up to date image of all the information processing devices (1.1-3.3) integrated with the enterprise network. When a new (or updated) program module (NPM) is to be installed on the whole or any part of the enterprise network, the NPM installation is first run against an emulation of the enterprise network devices and any existing core program modules (CPM) (1.1′-3.3′) in the test server. A predetermined test protocol is tailored to the specific enterprise network and designed to ensure that installation of the NPM does not result in serious adverse effects on the effective operation of the emulated enterprise network for instance due to conflicts with other CPMs. In particular the tests applied to the emulated enterprise network can be applied to programs or configurations which are proprietary to the enterprise and often mission critical. The test server is arranged to be controlled from a data centre server (1) outside the enterprise network firewall. Where adverse effects are detected in emulation the test server prevents installation of the NPM to the real enterprise network. The test serve can identify indices relevant to the fault and use such indices in a database correlating known fixes with the fault. Selected fixes can be applied to the emulated enterprise network for testing with the NPM. Where this results in no-fault condition the selected effective fix and NPM is applied to the real system.

### TECHNICAL FIELD

An information processing system comprises at least one and commonly many, often thousands of information processing devices. An information processing device is any device capable of information processing. Inexhaustive examples of information processing device's include a desktop computer, a mobile phone, a tablet and a servers. It may also include networking and peripheral devices such as a router, printers, network attached storage devices and scanners.

An information processing device consists of hardware, and software. Hardware will include at least data input means, data output means, a data processor, volatile memory, non-volatile memory and a power supply. Software will include “core programs” and “application programs”.

Core programs include, by way of inexhaustive example, software such as: basic input output system (BIOS), Unified Extensible Firmware Interface UEFI, the operating system (OS) and device drivers. Core programs are typically configured for specific devices or users to deliver system performance.

An application program performs tasks for the benefit of the user and include, by way of inexhaustive example: web browsers, word processors, spreadsheets computer aided design (CAD). Applications are the main purpose of the information processing device (information processing device) in many cases because they allow useful work to be performed, or entertainment to be delivered via a human machine interface.

Most devices are networked. The network will in most commercial cases rely on hardware routers to manage network data traffic on devices connected to an enterprise network and gateways to control traffic to other networks including large area networks such as the internet and/or other enterprise networks. Gateways and routers rely on core programs to deliver networking and security services to the network.

Either of a core program or application program is comprised of modules of software code. From time to time any program may be updated from a source, usually with at least one of the objectives of addressing security issues, improving performance, repairing or adding to the functionality of the core or application programs. Updates commonly involve any or all of the substitution of a whole program, one or more modules or changes to program settings.

Many enterprises operate large numbers of data processing devices sometimes numbering in the thousands or tens of thousands. Few of these devices will have identical hardware and operate identical suits of core or application programs. Providers of software updates (ie one or more new programs or program modules) will usually have tested any updated new program module in some standardized in-house hardware and software test environment (alpha testing), and in some cases beta testing before general release. The test environment will not be identical to any other (non-alpha or beta) particular enterprise environment as each user and enterprise has a unique configuration.

Conventionally only the new program module functionality is subject to limited testing. For example, the test merely confirms that the module is reported installed in the program registry or at most launches on command. In consequence installation of a new program module in a particular real enterprise environment often has unexpected, deleterious impacts on the functionality of one or more core programs, or application programs, in an information processing device receiving the new program modules. When it is recognized that certain application programs may be essential to the performance of certain critical business tasks, the cost of software updates causing lost productivity is severe.

### PRIOR ART

The most relevant known prior art is disclosed in U.S. Pat. No. 7,594,219B2. The flow chart of FIG. 1 illustrates the process for testing a new program module (NPM) installation in a device environment described in U.S. Pat. No. 7,594,219B2. After the program starts at step 1 the system identifies the new program module at step 2. U.S. Pat. No. 7,594,219B2 is silent on how a new program module is identified. However, it is common knowledge to the person skilled in the art that program modules are identified by documented indices such operating system type, product name, version and install location.

At step 3 the system selects a library of installed software module combinations (LISMC) which may include the new software program module.

At step 4 the system selects a device environment. The device environment is essentially the “device existing installed program module combination” (DIPMC) known to be installed on a information processing device is “identified”. The only environment software modules described in U.S. Pat. No. 7,594,219B2 are those comprising the operating system. No mechanism is described for identifying the DIPMC other than the documented OS environment data, i.e. the operating system type, product name, version and install location which will typically be documented on the information processing device. Moreover there is no report of how the documented operating system environment data is identified. Which suggests the documented operating system environment data is discovered from the information processing device and input by an operator. This implies a manual identification step is required every time one or more new program modules are to be installed, otherwise the system must rely on historical records manually updated which may not be reliable.

At step 5 having identified the operating system environment for the information processing device the system of U.S. Pat. No. 7,594,219B2 accesses a knowledge base and seeks an historical report of the compatibility of the identified new program module and the identified operating system environment, in FIG. 1 described as an installed program module combination (DIPMC). If the sought after combination is found in the knowledge base the system goes to step 6 where the report is interrogated to determine if the installation of the NPM and the installed operating system environment is safe. As illustrated in FIG. 5 of U.S. Pat. No. 7,594,219B2 the system can return a range of safety reports ranging from unsafe to 25% safe or 75% safe or unknown combination. According to threshold safety levels acceptable to the user the system may then pass the new program module for installation at step 7. If the combination of the new program module and the operating system environment is unknown, step 9 is implemented to pass the new program module for installation and “heart beat” testing on a test server running an operating system matching the operating system environment of the information processing device at step 10. Only the new program module and the identified operating system are tested at step 10.

If the heart beat test confirms that the new program module is available after installation on the test server, the process goes to step 7 where the combination of the NPM and the identified operating system are reported as safe and installation on the target device can be implemented. A bad heart beat test is reported at step 13. At this point the heart beat test for the new combination of the new program module and identified operating system are reported to the knowledge base and the new program module is not installed in the bad combination.

The system of U.S. Pat. No. 7,594,219B2 only tests a system environment which is the specific installed operating system, version and build.

U.S. Pat. No. 9,703,691B1 discloses a system of providing either of, a virtual test device or a physical test device, for a new program module comprising an application program. Operating data processing hardware is provided to select a compatible test device based on a compatibility test of the new program application module. The new program application module is routed to the selected test device. The new program application module is run on the test device in order to test the functionality of the new program application module, in the test device environment. Selection of the test device is according to the ability of the test device to either emulate or provide one or more of the permissions required for execution of the application. In practice this will mean that the test device operating system must be emulated or run on the virtual or physical test device. This system and method is limited to testing the functionality of the operating system and the new application program. Testing of the operating system is limited to the ability of the operating system to support the execution of the new application program.

US 201110321014 A1 is a system for testing the compatibility of a new program module with a target computer platform (operating system). This is achieved by comparing configuration parameters of the new program module (computer application) against a database and reports compatible and incompatible parameters.

US20144282395A1 discloses a method for checking the compatibility of a new program module (an application) and a software framework (a core programs) where the new program module is an update of a program module previously compatible with the core programs. A plurality of features of the old application and the core programs are recorded as a known compatibility baseline. Changes to the feature sets of each of the new program module and the core programs are identified. Compatibility is found if one feature set is found within the feature set of the other. This approach requires a knowledge of the respective feature sets in each of the old and new program modules, something which may be possible where the program modules are from a common source.

US20160060560A1 is a system for testing the installation and uninstallation of a new program module (proposed software). It does not test the impact of the new program module on the pre-existing core and application program environment.

The process of US2016132420A1 is illustrated in FIG. 2 herein and discloses a system for testing updates of an operating system (operating system environment) loaded on a single isolated information processing device. When the system recognizes that an update of the operating system is to be installed on the information processing device at 2.2, the operating system of the target device is identified at step 2.3. At step 2.4 a “first clone” of the operating system environment is created running in a virtual machine (test server). The update is applied to the first cloned operating system at step 2.5 to create a new virtual operating system (second clone environment). The new operating system is then tested in the virtual machine at step 2.6. If the new updated virtual operating system passes testing at step 2.7 the new operating system update is applied to the real operating system at step 2.8. If the tests at step 2.7 are failed the update is reported at step 2.9.

An object of the present invention is to provide a system for monitoring compatibility of program modules in a information processing device capable of information processing which alleviates at least some of the technical limitations evidenced by the referenced prior art.

### STATEMENT OF INVENTION

Accordingly the present invention provides a test server system for monitoring compatibility of program modules in an information processing device, the information processing device having: data input means, data output means, a data processor, a volatile memory, a non-volatile memory, a power supply, an operating system and one or more executable program modules recorded in executable form on said non-volatile memory to execute in response to a command input to the device:

said system comprising:
a test server, said test server capable of scanning the information processing device memory to identify and record:
the operating system and
each other executable device installed program module installed on the information processing device and,
said test server responsive to a command to virtually emulate:
   the information processing device operating system,
   any selection of the device installed program modules, and
   the installation of a new program module in the emulation of the information processing device,

characterized in that the test server will emulate the execution of at least one of the device installed program modules which is not the new program module, and not the operating system, subsequent to emulating the installation of the new program module and test the functionality of the device installed program module to confirm that the functionality of the device installed program module is not impaired by installation of the new program module.

The effect of the system of the invention is to create an up to date record of the information processing device environment, that is to say the core programs including the operating system, the executable core programs other than the operating system, and application programs. While the system may test the operating system it will also emulate and test core programs other than the operating system. Most importantly the system will test the functionality of the suite of device installed application programs present on the information processing device prior to the application of the new program module to confirm the continued functionality of the applications and non-operating system core programs after application of the new program module.

The new program module may be a module of any of a core program or an application program. A core program is any of a program module of the system, firmware, including any of: BIOS, EFI, or UEFI, or a system program module including any of: a module of an operating system, a device driver or a utility.

In a real use environment program modules are required to provide functionality in combination with one or more other program modules. The test server may be responsive to commands to select and emulate the simultaneous execution of a first combination of: a first device installed program module, and a second device installed program module. The test server is preferably responsive to commands to apply functionality tests to the combination of executing device installed program modules which measure and report the functionality of each executing device installed program module.

Tests may range in scope. A simple test may inspect the program files folder or equivalent and report that the subject program module is reported present in the program files. A basic launch and load test may require the test server to respond to commands which run the program module and confirm that the device installed program module exhibits behaviour confirming that it is running. A business process test may require a program module to perform a specific task. For example if a combination of device installed program modules is a word processor and a database, the word processor may run a script file to call customer information from the database and insert it into a standard test document.

In response to the completion and reporting of tests on the first combination the system may respond to commands to select a second combination of device installed program modules.

The combinations of device installed program modules may be manually selected by use of an interface to emulate the combinations of device installed program modules commonly encountered during the use of each specific information processing device. Sequences of combinations for test may be recorded and replayed each time that a new program module is to be tested for installation on an information processing device thereby automating a lengthy and complex test process so that it can run with little or no human intervention.

The test server may advantageously include a usage capture module capable of capturing program module execution data for every program module installed on the or each information processing device to form a usage record. Program module execution data may include the time of execution and/or the processor usage and/or memory usage.

The test server includes an adaptive test module responsive to said usage record to select typical usage patterns and combinations. The adaptive test module is responsive to the patterns and combinations to create test setups and sequences of program modules for testing. For example combinations of program modules reported as executing concurrently with a high frequency in the usage record will be tested in emulation. Users will commonly use specific combinations of program modules, especially where the program modules are applications, according to the user's work function. Preferably the test server selects combinations of application programs for test where the period of concurrent usage is above a threshold value, or where the frequency of concurrent usage is above a threshold value. This allows the number of combinations requiring testing to be reduced to a more manageable level.

The system is most useful in testing a plurality of information processing devices in an enterprise network. Enterprise networks frequently comprise large numbers of disparate devices. The information processing devices comprising an enterprise network will usually have a range of hardware components, will be provided with differing core programs and differing suites of application programs. The information processing devices will commonly be deployed over two or more geographical sites and will have different configurations to accommodate, for example, a range of human user languages. The application programs will be used differently according to how individual users perform their jobs. Commonly a specific information processing device may need to access resources stored on a separate information processing device of the enterprise network.

The test server of the system is able to communicate with each information processing device of an enterprise network and capture the complete executable program module suite associated with each information processing device constituting the enterprise network. The test server can consequently emulate either, each information processing device or a group of information processing devices from the enterprise network. The usage capture module enables the usage of device installed program modules to be captured from several information processing devices in the enterprise network.

When the system is applied to an enterprise network combinations of applications may be selected from running emulations of multiple information processing devices. For example a word processor running in emulation on a first information processing device may be tested in combination with a database running in emulation on a second information processing device. The test may for example comprise script requiring the word processor to call customer data from the database, insert the data into a letter and observe that the result is as expected. Tests may also observe the resource usage of the emulated devices as they emulate the device installed program modules in order to confirm that the result of the installation of the new program module does not lead to excessive resource usage. Resources for this purpose may include the operation frequency of the central processor unit or cores thereof, random access memory, read only memory and network traffic. Resource usage out of expected ranges may indicate a technical problem with the system which could lead to unwanted effects ranging from the system slowing down and freezing.

Commonly when the information processing device is selected from an enterprise network of information processing devices specific groups of users within an enterprise network may have similar application combination usage behaviour. The adaptive test module may exploit the usage record to correlate similar patterns of usage combination in order to identify groups of users who use applications in similar combinations. The group combinations so identified can therefore be tested to verify the compatibility of the new program module for the whole group of information processing devices. An example of such a group might include an accounting department where the entire group uses an office suite, including a word processor application and spread sheet application, an email client, web browser and a custom database almost continuously. Other applications may be available to that group but are deemed to be below a critical threshold and do not require combination testing. Such applications will have an application reliability priority value allocated either manually or automatically by the usage capture device. Some executable program modules may be manually allocated a low application reliability priority value because their reliability has little or no impact on a user's activities. For example, in most business environments device installed program modules providing games services will have little or no impact on the target device's normal use to deliver business services. Isolating such program modules so that their performance is not checked either in isolation or in combination can reduce the work load required of the test server.

Mission critical device installed program modules provide services which are commonly critical to business functionality and must always be thoroughly tested even if infrequently used on specific information processing devices. Such device installed program modules may be exemplified by banking transaction applications, network security applications or patent online filing programmes. Accordingly the test server may accept manual input of an application reliability priority value, said test server responding to the application priority value to determine a standard of test protocol to apply with regard to the specified application program. The test server may be responsive to the highest application reliability priority value to test the application program in every possible combination of applications for the device and with every available functionality test.

Enterprise networks are commonly secured behind firewalls with servers and other information processing devices accessible only from networked clients by way of business and client specific security protocols. Security tokens such as password, biometric data and other sensitive data is required to access and test the system. Furthermore, testing some applications may require access to critical business data (i.e. financial software by its nature will access all the enterprise's sensitive financial data). To accommodate these requirements the test server is preferably located behind the device or enterprise network firewall. Thus the system protects enterprise network critical systems by ensuring sensitive data remains behind the enterprise network firewall. The test server is arranged to receive commands to run tests from an authorized operator outside the firewall and only provides a quantitative and/or qualitative pass/fail value to the operator via the interface provided by the data centre server. Custom built business specific applications are the most vulnerable to updates, likely to be the most highly secured and are commonly business critical. The security policy of most enterprises will be such as to preclude access to security tokens such as passwords and security protocols outside the business' immediate control. Conversely many such enterprises will wish to retain service providers for information technology support. Accordingly the test server and the information processing device is preferably located behind an enterprise network firewall and provides a gateway in the form of a reverse proxy server. The test server gateway provides secure access to security tokens to enable access to enterprise network information processing devices and to enable application functionality to be credibly tested. The test server provides the gateway function, and the hardware and software to emulate one or more, usually many more than one information processing devices being able to load and test any configuration selected by the system. However the test server may be controlled from a data centre server communicating through the enterprise network firewall to command the performance of emulation testing on the enterprise network and to receive the results of the emulation testing. The results will commonly be in the form of a qualitative pass or fail with respect to the application of the new program module on a group, a set of groups or the whole of the enterprise network, or a quantitative report of the impact on resource usage, eg the installation of the new program module results in a 10% increase in information processing device memory usage or a 5% reduction in network traffic.

By means of the test server system an enterprise network or groups of devices within an enterprise network may be closely emulated, as they are configured, and operated within the real enterprise network. Changes proposed to the real enterprise network may be tested in the emulation to confirm the functionality of the network in emulation before imposing the changes on the real enterprise network. Control of the test process may be directed from a single control station such as a data centre server located outside the enterprise network firewall. The outcome of the test process may be reported to the control station without data stored on the network including security tokens, ever leaving the enterprise network. The test server system may automatically adaptively develop test procedures and may apply the procedures largely or wholly automatically.

According to a further preferred aspect of the present invention the test server provides a remediation service. When delivering the remediation service the test server is responsive to the determination that a new program module generates a fault condition to seek a potential solution to the fault condition. Where a potential solution to the fault condition is identified the test server applies the solution to the emulation of the system under test, this is known as a “fault mediated emulation”. The test server will now repeat the process of emulating the execution of each device installed program module which is not the new program module, and not the operating system which lead to the fault condition test result. If the fault condition is no longer reported by the test server, the test server applies or permits the application of the identified solution and the new program module to the real system.

To prevent the remediation service cycling an excessive number of times where no good solution is quickly identified, the system may put a predetermined limit on the number of attempts to find a solution.

Preferably the remediation service is implemented by the test server capturing any fault message generated by the system emulation. The fault message is then used to address a database of known solutions. The database may be located outside the enterprise network firewall. It may be advantageous to access the database via a control centre server situated outside the enterprise network firewall. As is generally known in the art such solutions may be illustrated by actions such as: changing system settings, updating drivers, modifying registry keys, updating the operating system, updating an application, applying upgrade packs, changing configuration, or changing dependencies.

The present invention can provide a test server system having a test server situated behind an enterprise network firewall. The test server is arranged to capture an up to date image of all the information processing devices integrated with the enterprise network. When a new program module (NPM) is to be installed on the whole or any part of the enterprise network the NPM installation is first run against an emulation of the enterprise network in the test server. A predetermined set of tests are applied, designed to ensure that there are no serious adverse effects on the effective operation of the emulated enterprise network. In particular the tests applied to the emulated enterprise network can be applied to programs or configurations which are proprietary to the enterprise and are often mission critical. The test server is arranged to be controlled from a data centre server outside the enterprise network firewall. Where adverse effects are detected in emulation, the test server prevents installation of the NPM to the real enterprise network. The test serve can identify indices relevant to the fault and use such indices in a database correlating known fixes with the fault. Selected fixes can be applied to the emulated enterprise network for testing with the NPM. Where this results in a no fault condition the selected effective fix and NPM can be applied to the real system.

### BRIEF DESCRIPTION OF THE DRAWINGS

Embodiments of a test server system for monitoring compatibility of program modules in an information processing device capable of information processing will now be described, by way of example only, with reference to the accompanying illustrative figures, in which:

FIG. 1 is a flow chart illustrating a prior art system useful for understanding the invention;

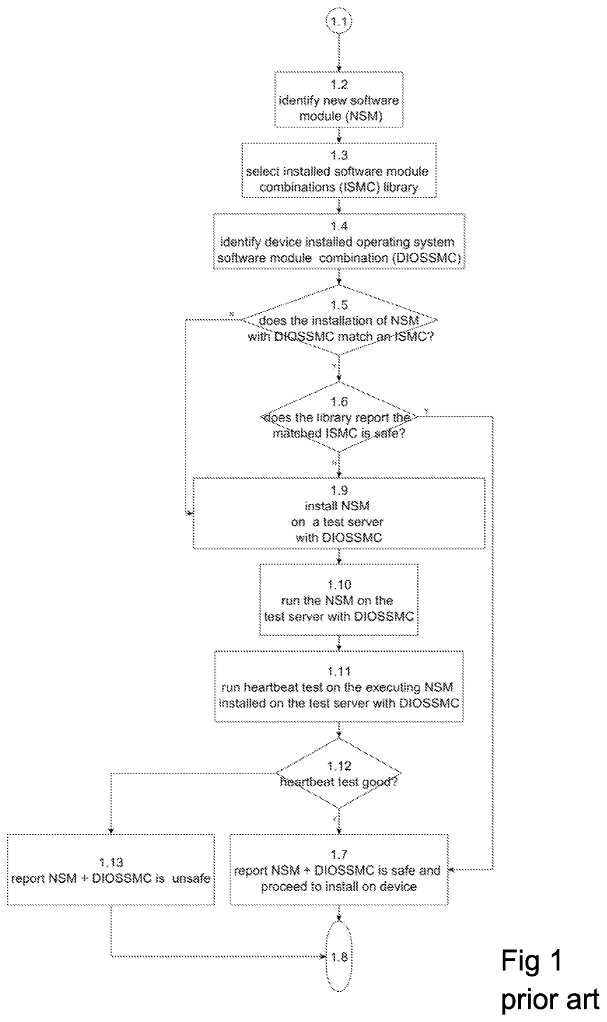

FIG. 2 is a flow chart illustrating a prior art system useful for understanding the invention;

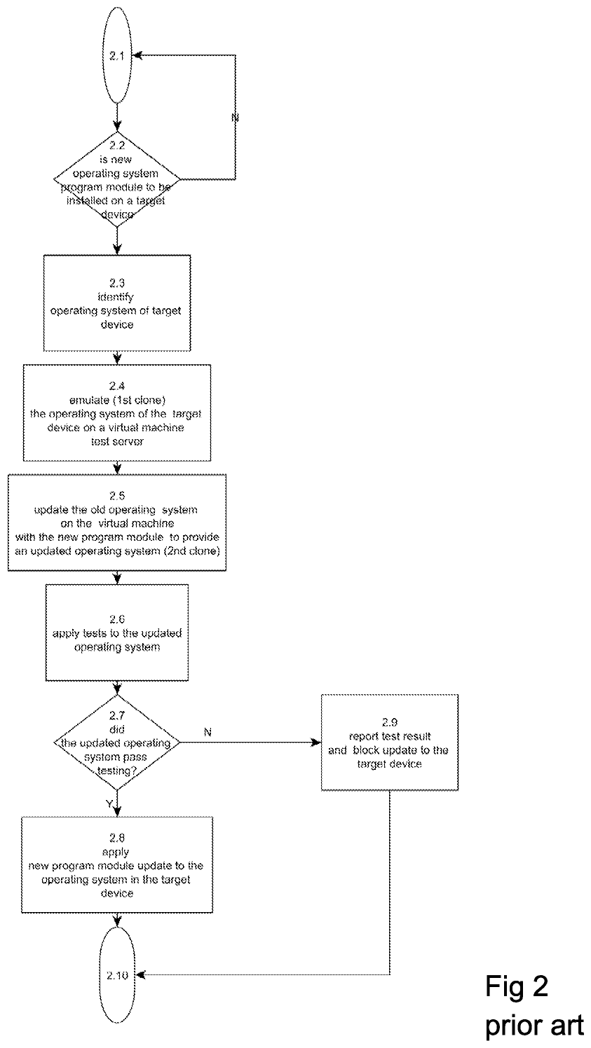

FIG. 3 is a diagrammatic illustration of a information processing device;

FIG. 4 is a diagrammatic illustration of a plurality of groups of information processing devices;

FIG. 5 is a flow chart illustrating a first embodiment of the process steps of the test server system;

FIG. 6 is a diagram illustrating the architecture of the test server system;

FIG. 7 is a flow chart illustrating a process for grouping information processing devices in a second embodiment of the invention;

FIG. 8 is a flow chart illustrating an application testing and reporting procedure implemented in the test server system;

FIG. 9 is a flowchart illustrating dataflows for the test server system controlled from a data centre server operated by a support provider,

FIG. 10 is a flowchart depicting a mediations service provided by the test server, and

FIG. 11 is a flowchart depicting selection of a possible fix for a fault state.

### DETAILED DESCRIPTION OF FIGURES

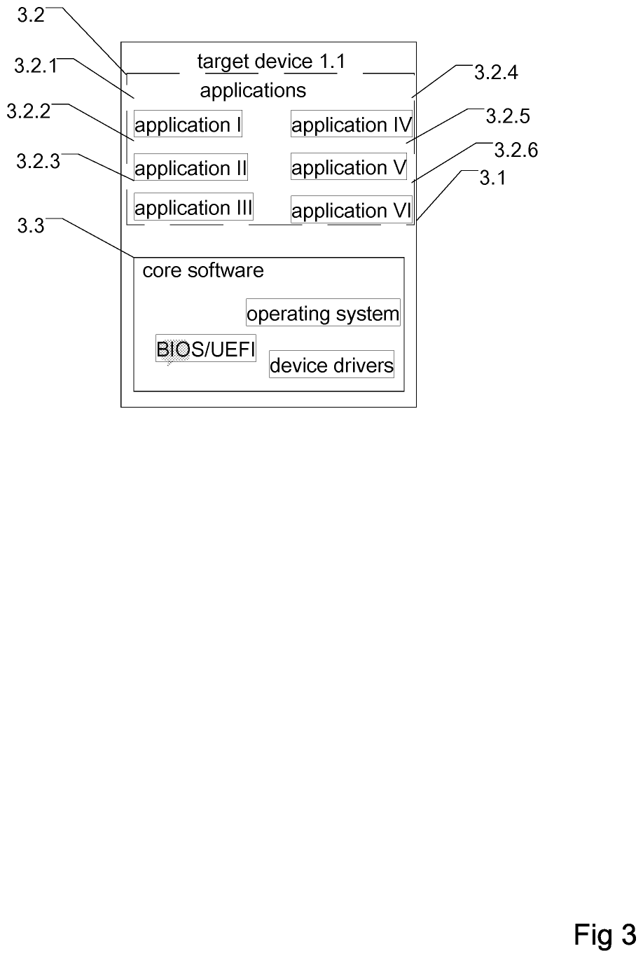

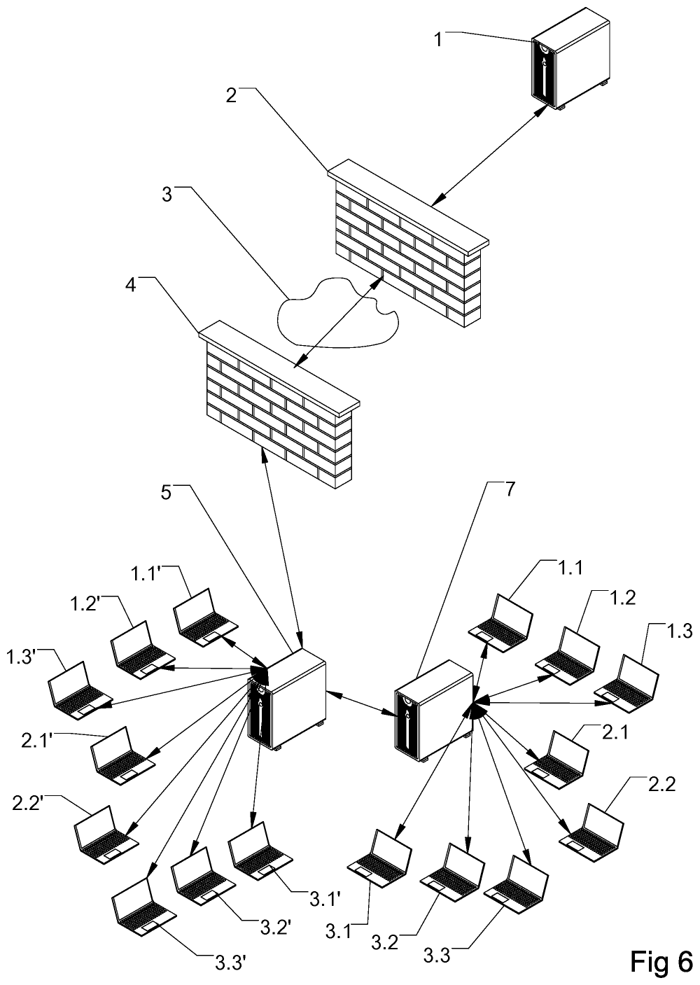

FIG. 3 diagrammatically illustrates a information processing device 1.1 such as the information processing device 1.1 illustrated in the system architecture FIG. 6. The typical information processing device resides in an enterprise network and may be any of a computer such as a desktop PC, lap top, smart phone or a system device such as a server, modem or router. Such devices will have hardware components typically including a motherboard, supporting a processor, random access (volatile) memory, non-volatile memory, input means such as a keyboard, touch screen, camera and microphone as well as output devices including a visual display unit and speakers. Commonly devices will include ports for the provision of wired and/or wireless communications interfaces. Such features are common place to the person skilled in the art and have not been illustrated for that reason.

A typical information processing device will also support a software suite, typically the software suite comprises core programs 3.3 and application programs 3.2. The core programs will typically include a basic input output operating system (BIOS) or unified external firmware interface (UEFI), device drivers and an operating system such as Microsoft Windows®, Android®, macOS®, iOS® or Linux. Applications are inexhaustively exemplified by programmes such as web browsers, email clients, spread sheets, word processors, databases, and custom built business processes.

FIG. 6 illustrates a typical system architecture implemented by the test server system. A data centre server 1 provides information technology support to the enterprise network and in this case manages the process of updating the exemplary enterprise network. The data centre server sits behind a firewall 2 and communicates through the internet 3 and enterprise network firewall 4 with a test server 5. The data centre server 1 thus provides a command and report interface with the test server whereby the test server can be directed to perform specified tests and the results of the tests are reported to the data centre server 1.

The test server 5 works with a gateway device (not shown). The gateway device may be physically part of the test server or a separate component. The gateway mediates communication between the test server 5, the data centre server 1 and a systems management product, such as the Microsoft® system centre configuration manager (SCCM) 7. The gateway may include a store for security tokens to enable device installed program modules to be accessed and launched. By virtue of this arrangement enterprise network security tokens and data never leaves the enterprise network.

The SCCM 7 has access to the enterprise network information processing devices 1.1, 1.2, 1.3, 2.1, 2.2, 3.1, 3.2, 3.3. The SCCM 7 enables the provision of remote control, patch management, operating system deployment, network protection, hardware and software inventory and other services as is known to the person skilled in the art. Although the SCCM 7 is shown as a separate device it may be implemented in the same hardware as the test server 5 and the gateway. The seven devices illustrated are intended to be representative of the thousands of devices commonly supported on an enterprise network. The SCCM device at 7 may also provide active directory domain services providing authentication and authorization to users. The SCCM device at 7 may also provide a security account manager.

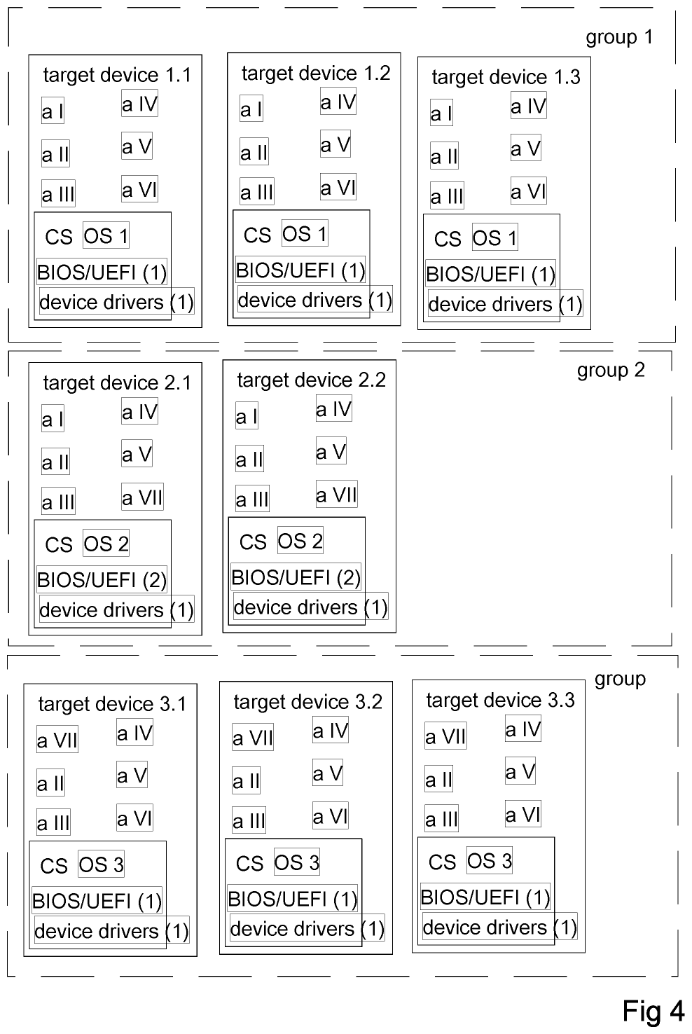

The test server 5 is authorized to request scans of each and any information processing device 1.1, 1.2, 1.3, 2.1, 2.2, 3.1, 3.2, 3.3 in order to determine each executable program module operably installed on each information processing device and provide a record of the core programs and application programs recorded on each information processing device as diagrammatically illustrated in FIG. 4.

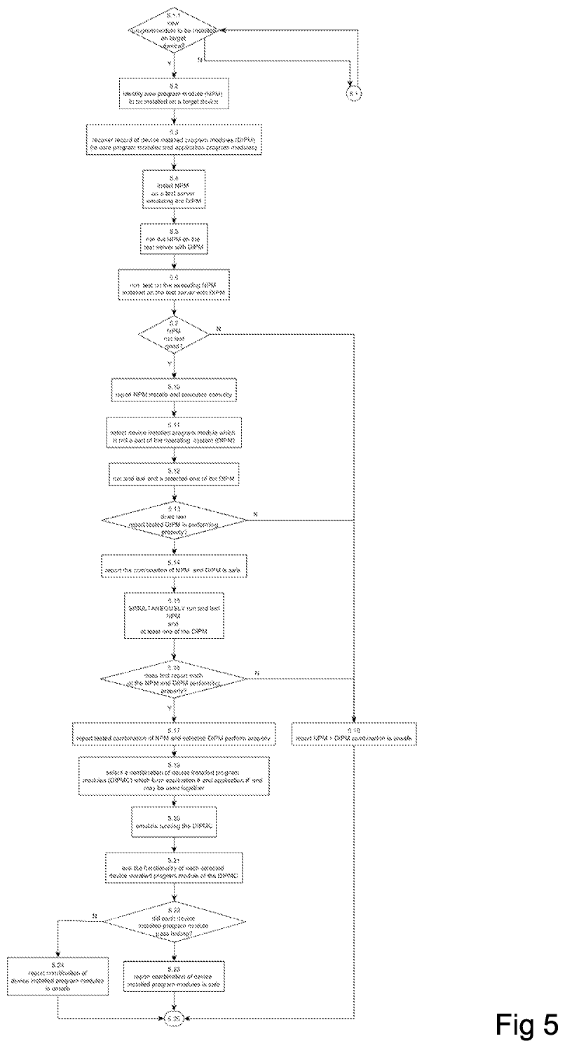

FIG. 5 illustrates the process implemented by the test server system. At step 5.2 the data centre server 1 identifies a new program module (NPM) is to be installed on any selection of the information processing devices 1.1, 1.2, 1.3, 2.1, 2.2, 3.1, 3.2, 3.3. Commands to implement a new program module test procedure are sent to the test server 5 through the firewalls 2 and 4 via, in this case, the internet. Any other suitable wide area network may be used. At step 5.3 the test server 5 recovers a record of the device installed program modules (DIPM) installed on each real information processing device 1.1, 1.2, 1.3, 2.1, 2.2, 3.1, 3.2, 3.3 to which the NPM is to be applied.

The record of DIPM are initially created by the test server by scanning each information processing device during test server system set up, or when a new information processing device is added to the enterprise network. Ideally all device updating is then managed via the test server system which then continually updates each information processing device record of program modules.

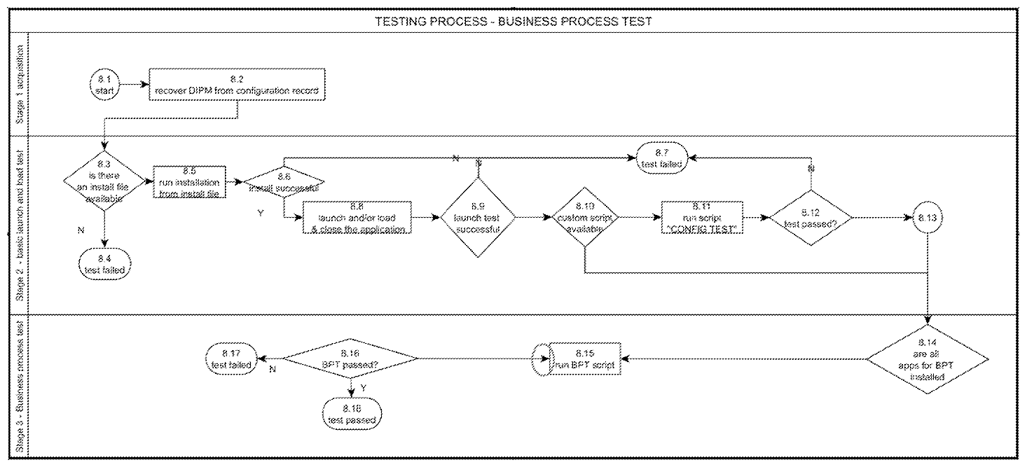

At step 5.4 the test server establishes a virtual machine emulation 1.1′, 1.2′, 1.3′, 2.1′, 2.2′, 3.1′, 3.2′, 3.3′ matching each information processing device 1.1, 1.2, 1.3, 2.1, 2.2, 3.1, 3.2, 3.3. The NPM is then installed on each virtual machine 1.1′, 1.2′, 1.3′, 2.1′, 2.2′, 3.1′, 3.2′, 3.3′ and the test process illustrated at FIG. 8 is applied to each virtual machine. Accordingly at step 5.5 the test server runs the NPM on each virtual machine 1.1′, 1.2′, 1.3′, 2.1′, 2.2′, 3.1′, 3.2′, 3.3′ in the enterprise network and applies tests to see if the NPM has installed and executes correctly.

At step 5.7 the test server either reports that the NPM passed the test stage or failed and reports failure at step 5.18. The test at step 5.17 will at least include running the operating system for the virtual device 1.1′, 1.2′, 1.3′, 2.1′, 2.2′, 3.1′, 3.2′, 3.3′ in order to support the NPM. It may include running one of the applications of which the NPM forms a part.

The system reports that the NPM is installed and executes correctly at step 5.8 and goes to step 5.9 where a device installed program module which is not part of the operating system is selected. At step 5.10 the selected DIPM is tested. If the DIPM passes testing the system goes to step 5.12 where the test server reports that the selected DIPM has passed testing. If the selected DIPM fails testing the system goes to step 5.18 where the DIPM is reported as having failed testing.

At step 5.13 the test server system selects and runs each of the NPM and DIPM while subjecting each to testing to confirm proper function of each when run simultaneously. At step 5.14 each of the DIPM and NPM are judged to have passed or failed testing and if either fails the system goes to step 5.18 to report the combination is unsafe. If the combination passes testing at 5.14 the system goes to step 5.15 where a pass is reported and the system goes to step 5.16 where a combination of device installed program modules (DIPMC) is selected for testing. In this example the device installed program modules are modules forming application programs which may be used together. At step 5.17 the test server emulates running each of the selected DIPM. At step 5.19 each DIPM is tested to confirm the functionality of each of the selected DIPM.

At 5.20 the system judges whether each of the selected DIPM tested in combination passed testing and reports the combination is unsafe at step 5.22 or safe at step 5.21.

At step 5.16 the test server selects a combination of device installed program modules each of which provides an application capable of being run together on the virtual device 1.1′, 1.2′, 1.3′, 2.1′, 2.2′, 3.1′, 3.2′, 3.3′ . By way of example the applications may consist of “aI” and “aII”. Running each application is emulated at step 5.17 and subject to a battery of tests at step 5.19 to confirm that it continues to execute correctly after installation of the NPM. In this way the client can be confident that when any of the real devices 1.1, 1.2, 1.3, 2.1, 2.2, 3.1, 3.2, 3.3 is updated with the NPM the applications will continue to function correctly.

The test server is able to cycle through tests of every possible combination of applications automatically, allowing comprehensive testing of the impact of any new program module without human intervention prior to installation on a real system. The test server actually provides a close emulation of an enterprise network target environment and use, not merely the isolated ideal test cases proposed by the prior art.

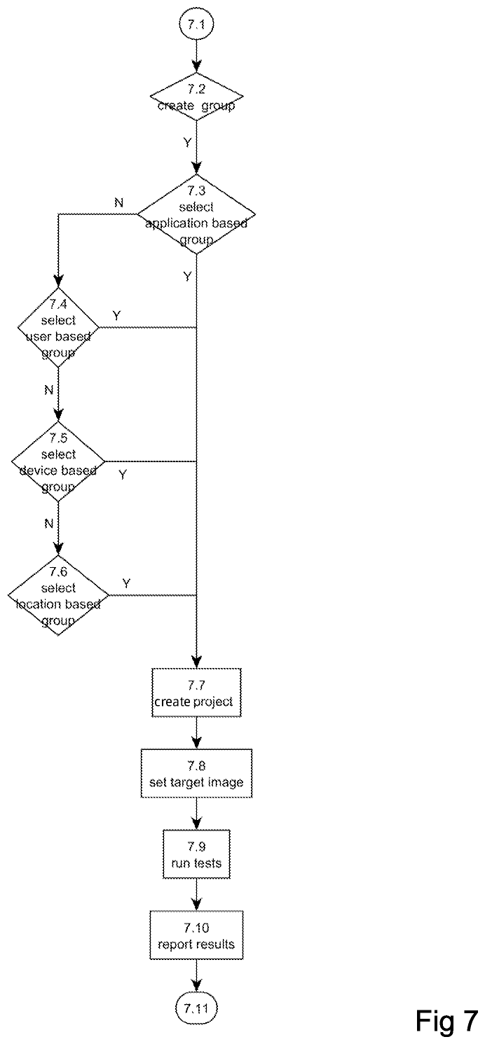

FIG. 7 illustrates a process whereby the number of combinations of applications to be checked can be alleviated by collecting information processing devices into groups. When this subroutine is deployed by an operator the operator selects a create group function at step 7.2. At step 7.3 the operator is invited to select an application based group in which target machines with similar combinations of applications are selected, as illustrated in FIG. 4 which shows group I with three information processing devices each having similar application programs. If application based grouping is not selected at step 7.4 the operator can select device based grouping at step 7.5. If device based grouping is not selected at step 7.5 the operator can select geographical location based grouping at step 7.6.

When grouping has been selected the process allows selection of a project at step 7.7. A project may be a test process in which predetermined levels of testing are selected for the group. For example certain mission critical applications for a group are subject to more thorough testing than less critical applications.

At step 7.8 the target image is set by the test server. The target image is the emulation of one or preferably more than one information processing device 1.1′-3.3′. At step 7.9 one or more tests are performed automatically on the target image devices. Thus combinations of program modules are automatically launched. That each program module is running may be tested. For example a smoke test may be applied to ascertain that the critical functionalities of the program module are working. Business process tests (BPT) may then automatically be applied to the device installed program module combinations. Such tests will be defined by script files and replicate the user's normal or common usage of the device installed program module combination. For example a BPT may require a program modules providing a spread sheet to call data from a database, insert it into the spread sheet, perform a calculation and check the calculated data is correctly entered into the spread sheet before closing the device installed program module. At step 7.10 the test server reports the results of the test to the data centre server 1.

FIG. 8 shows a process in which after starting the process the application list is pulled from the SCCM 7 at step 8.2. At step 8.3 the test server looks for an install file for the program modules. If no program file is available for a specified program module the process will report fail for that module at least at step 8.4. Where an installation file package is available the system will install the file to the virtual machine at step 8.5. At 8.6 the test server judges if the installation is successful or not and reports a fail at step 8.7. If the install is reported successful the application is launched, loaded and closed at step 8.8, ie a basic launch and load test to confirm the applications appear to execute on command. The basic launch and load test at 8.8 reports a fail at step 8.9 and if passed may proceed to step 8.1. At step 8.1 a custom script is sought from memory to provide a test routine specific to the functionality of the application. For example the application may be launched, required to open a file, close and save the file. The outcome of this test at 8.11 is reported at step 8.12 as a fail to step 8.7 or if passed the system goes to step 8.13. At step 8.13 the test server seeks files for a business process test to further challenge the functionality of an application or applications running through the test process. At step 8.14 the system confirms that all the applications for a business process test are installed. The business process test script is then run at step 8.15. The outcome of the business process test script is reported at step 8.16 to fail at 8.17 or pass the test at 8.18.

If no custom test script is available at step 8.10 the process may go directly to step 8.14. A custom test script can be auto generated by the invention, captured from user devices, or created manually by a user to drive a configuration test or a particular business process test (BPT). For example the test server may respond to a business process script by launching two or more device installed program modules, one on each of two or more emulated information processing devices. Causing a first program module comprising, for example, a spread sheet application, to call data from a second program module comprising a database. The spread sheet might then perform calculations on the data. The resulting calculations might then be used to generate a table and or chart and sent to a web publishing program module.

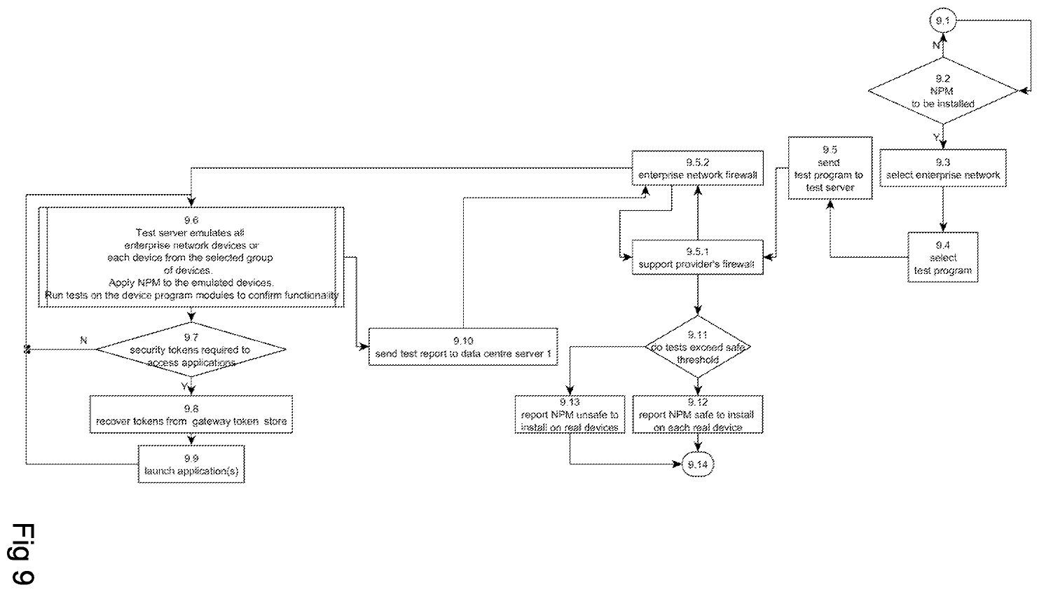

FIG. 9 illustrates the data flows for a test server systems such as that diagrammatically illustrated in FIG. 6. The process starts at 9.1 and where the data centre server 1 judges that a new program module is to be installed in a client enterprise network at step 9.2. A client enterprise network is selected at step 9.3 and a test program scheme is selected at step 9.4. These may be manually selected by an operator or may be automatically pre-determined by factors such as the specified client enterprise network. The test program selection is then sent to the test server 5 passing through support provider firewall at step 9.5.1 and the enterprise network firewall at step 9.5.2. The test program then reaches step 9.6 where the system runs the process previously described at FIG. 5. If any program module or test requires passwords or other security tokens to be run in emulation as judged at step 9.7 the test server poles the SCCM server 7 at step 9.7 for access to the launch the required application program and runs the application program at step 9.9.

When the test results become available from step 9.6 the test reports are sent to the support server 1 via step 9.10 back through the firewalls.

The test reports will then indicate if the NPM is safe to install at step 9.12 or unsafe at step 9.13.

The system contemplates recording test processes to establish groups and test requirements for specific enterprise networks which can then be repeatedly run with ease and with minimal supervision.

The arrangement of the test server and connection to the SCCM allows the test server to capture usage data for each information processing device using a usage capture module. Usage data is captured to a data base where an adaptive test module of the test server examines correlations of usage combinations to determine which applications and other program modules are frequently used together. This allows the test server to intelligently select program modules for testing in combination with minimal operator intervention.

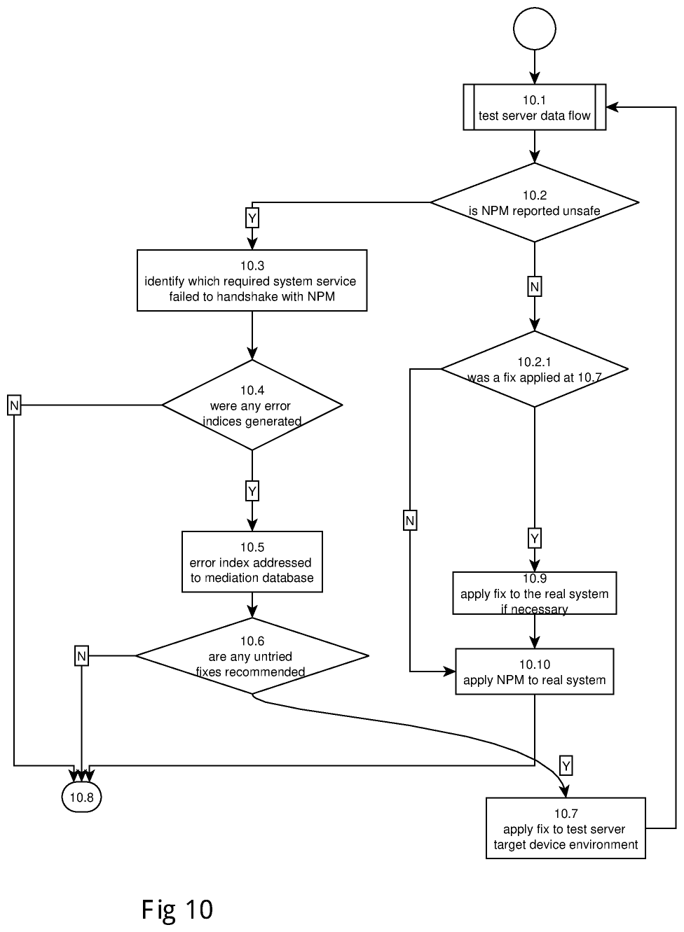

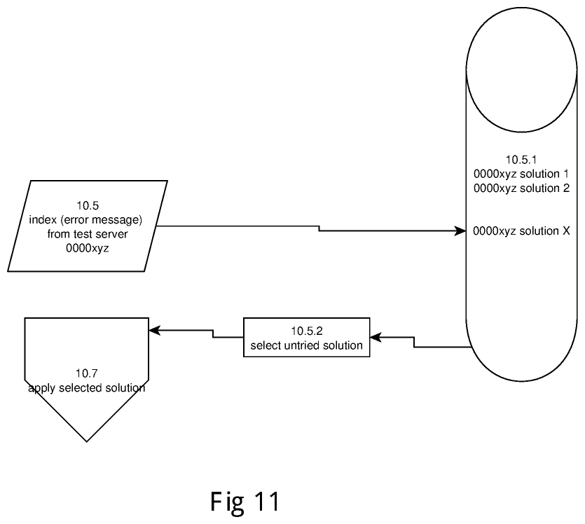

FIG. 10 illustrates a remediation service process provided by the test server where at step 10.1 the test server reports on the behaviour of a new program module. At step 10.2 the test server responds to a report that the new program module is unsafe by proceeding to step 10.3. At step 10.3 the test server seeks to identify which required system services failed with the new program module. At step 10.4 the test server captures any index such as an error message generated in response to the test process previously described and represented at 10.1. Other examples of indices include: 1. OS service call returns an error. 2. Unable to access a storage device such a disk. 3. Missing software library or component. 4. Unable to interact with a peripheral. 5. unable to access an external resource such as a database or a license server. A unique index can be generated, for instance, by identify the specific core software component service generating the error, along with the entire calling stack of functions services—which would make it unique. For example; imagine an application, calling a software library, which in turn calls an operating system service such as “open a file on a disk”, which in turn calls a device driver which actually accesses the disk drive. If the device driver returns an error, the entire sequence of actions can become a unique index, useful for searching for possible remedies. If no index was generated the test server ends the process and the application of the new program module to the real system is blocked. If an index such as an error message “0000xyz” in FIG. 11 is generated, the error message is captured and used to address a remediation database at 10.5, as illustrated in FIG. 11. The database is compiled with known fixes, to previously experienced or anticipated fault conditions, addressed by means of indexes such as the error message. The index points to machine implementable instructions for application to an information technology device or system of information technology devices. The test server responds to identification of an addressable solution to the captured error message to select the fix and apply it to the emulated system.

The test server will then run the test process which identified the fault condition against the new program module. If no fault condition occurs as judged at step 10.2 and a fix has been applied at step 10.7 as judged by step 10.2.1 the test server applies the selected fix if necessary to the real system at step 10.9 and the new program module is then applied to the real system at step 10.10. Step 10.2.1 judges where no fix has been applied at 10.7, normally because no fault has been detected when the new program module is first tested in the test server at 10.7, the system bypasses step 10.9 and applies the new program module to the real system at step 10.10.

1. A test server system for use in an enterprise network for monitoring compatibility of program modules in at least one information processing device in the enterprise network, the information processing device having: data input means, data output means, a data processor, a volatile memory, a non-volatile memory, a power supply, an operating system and one or more executable program modules recorded in executable form on said non-volatile memory to execute in response to a command input to the device:
said system comprising:
a test server, said test server capable of scanning each information processing device memory to identify and record:
the operating system and
each other executable device installed program module installed on each information processing device and,
said test server capable of responding to a command to virtually emulate:
each information processing device operating system,
any selection of the device installed program modules, and
the installation of a new program module in the emulation of the information processing device;
the test server is capable of emulating the execution of at least one of the device installed program modules which is not the new program module, and not the operating system, subsequent to emulating the installation of the new program module and test the functionality of each executing device installed program module to generate an impairment report that the installation of the new program module will have on the functionality of the device installed program modules in each information processing device characterized in that a data centre server is situated behind a data centre server firewall to communicate through the internet with the test server;
the test server has a gateway function provided by a reverse proxy server, said gateway function providing secure access to security tokens behind the enterprise firewall to enable application functionality to be credibly tested in response to commands from the data centre server and to report the outcome of each functionality test to the data centre server, without security tokens or sensitive data passing through the enterprise firewall.

2. A system according to claim 1 wherein the test server is able to prevent the installation of the new program module in each information processing device.

3. A system according to claim 1 wherein a program module is one of:
a core program or
an application program.

4. A system according to claim 3 where a core program is one of:
firmware, including any of: BIOS, EFI, or -UEFI
a system program module including any of: a module of an operating system, a device driver, a utility.

5. A system according to claim 1 wherein the test server can emulate the simultaneous execution of a first combination of:
the new program module, and
a selection of at least one of the application programs, and
subject each of the executing program modules to tests which measure and report the functionality of each executing program module.

6. A system according to claim 5 wherein the test server can automatically select a second combination of:
the new program module, and
a selection of at least one of the application programs, wherein the set of application programs from which the selection is made excludes any previously selected application program, and
subject the executing application program to tests which measure and report the functionality of each executing program module.

7. A system according to claim 1 wherein the test server selects a combination of two or more application programs from the set of application programs and emulates the execution of each selected program module, while subjecting each executing program module to one or more tests to measure and report the functionality of each executing application program.

8. A system according to claim 1 wherein:
the system includes a usage capture module capable of capturing the time of execution, of every program module installed on the information processing device to form a usage record,
said test server including an adaptive test module responsive to said usage record to select combinations of program modules reported as executing concurrently in the usage record.

9. A system according to claim 8 wherein: the test server selects combinations of application programs for test where the period of concurrent usage is above a threshold value.

10. A system according to claim 9 wherein: the test server selects combinations of application programs for test where the frequency of concurrent usage is above a threshold value.

11. A system according to claim 1 wherein the test server accepts manual input of an application reliability priority value as a level of acceptable and unacceptable device installed program module impairment, said test server responding to the application priority value to determine a standard of test protocol to apply with regard to the application.

12. A system according to claim 10 wherein:
the test server responds to the highest magnitude of the application reliability priority value to test the application program in every possible combination of applications for the device and with every available functionality test.

13. (canceled)

14. A system according to claim 1 wherein the test server and each information processing device in the enterprise network are located behind an enterprise firewall.

15. A system according to claim 14 wherein the test server emulates each of the information processing devices in the enterprise network.

16. A system according to claim 14 wherein the test server tests the functionality of combinations of two or more emulated program modules where at least two of said emulated program modules run on separately emulated information processing devices.

17. A system according to claim 1 wherein the test server provides a remediation service process such that:
the test server is responsive to an unacceptable impairment report to capture any error message generated in the test server as the new program module and/or any combination of device installed program module executes;
said test server addressing a database of fixes by means of the captured error report;
said test server selecting a fix and applying the fix to the information processing device emulation;
said test server responding to application of the fix to retest the emulated installation of the new program module and device installed program modules;
said test server responding to an acceptable impairment report at retest to permit the installation of the new program module.

18. A system according to claim 17 wherein the test server is able to respond to an acceptable impairment report at retest by implementing installation of the new program module in the or each information technology device.
